(19) United States
(12) Patent Application Publication
(10) Pub. No.: US 2004/0117267 A1
(43) Pub. Date: Jun. 17, 2004

(54) Engineering data interface and electrical specification tracking and ordering system

(76) Inventors: Mary Jo Kilburn, Cedar Park, TX (US); Kim P. Mulvey, Austin, TX (US); Stevan James Smith, Azle, TX (US)

Correspondence Address: 3M INNOVATIVE PROPERTIES COMPANY, PO BOX 33427, ST. PAUL, MN, 55133-3427, US

(21) Appl. No.: 10/319,035

(22) Filed: Dec. 13, 2002

(51) Int. Cl. G06F 17/60

(52) U.S. Cl. 705/26

(57) ABSTRACT

An portable electronic engineering data interface and tracker that includes a host system which receives written or electronic engineering data from an engineering company for a construction project or subproject, transfers the information to a software program that re-formats the information to provide device or product level data for use in determining specific products, marking requirements and making project management calculations, manages the data in a standard format and in one software package, manages revision levels and changes to engineering data from the field system, shared among several entities, analyzes data and reports any changes to said data, tracks progress of the project by work completion, distributes information by means of the software using email for portability, sorts termination data by specific location, device or system, and generates orders for products to be delivered.

### TECHNICAL FIELD

The invention relates to a hardware assisted system and business method for integrating work process and design data for the customization and delivery of products and services, management of project tasks and timelines, and management of materials within construction projects.

### BACKGROUND

In the construction industry, it is common for multiple engineering drawings, blueprints and spreadsheets to contain essential information about the project, all the subprojects, such as electrical and mechanical projects, and the components that need to be placed into the projects and subprojects. The industry has typically transferred this information on paper to databases, and manually to other parties involved in the business of building and managing the project, including such parties as subcontractors, vendors and suppliers, and site managers. The number of components were estimated, or manually counted, and ordered, which resulted in either large expenditure of time, under- or over-estimated orders, or both. Underestimated orders required adjustments, i.e., workman time lost while awaiting new parts; overestimated orders resulted in additional paperwork, refund requests, inventory restocking charges, scrapped materials and the like.

Changes made during construction, variations in “as-built” versus plan, and transcription errors regarding such changes further exacerbate these problems. Current methods to communicate timing and quantity of parts needed include electronic changes, hand written, transcribed to printers at off-site locations, and manually loaded hand-held printers. All of these systems are inconsistent, slow and error-prone.

These problems are especially difficult in a material intensive construction subproject such as the electrical project. Hundreds of thousands of wires and cables need to be marked and/or labeled consistently. Marking and identification are critical as is installation status, system start-ups, and “as-built” modifications to use for maintenance of the installed systems.

Processes exist within the industry for project management and identification of electrical cables, wires and systems. The current systems use varying degrees of integrated databases, computer assisted design (CAD) type drawing systems, paper drawings and internal documentation systems. The problem is that these systems tend to be specific to the project manager involved with the individual project. Thus multiple projects and subprojects may be managed using different systems. The systems and work processes are not easily transferable and reside with a specific individual. This prohibits a consistent product and can hinder the timeliness and cost of the project itself.

It would be desirable to have a system that provides a solid link between contractor, subcontractors, architects, vendors, owners and others in the construction industry. An automated system and a method of doing business using that automated system has now been developed, which eliminates much of the paper shuffling, counting and recounting, and returns generated by the old systems.

### SUMMARY OF THE INVENTION

The invention provides a portable system including a host system and a field system, the host system contains a hardware component and at least one software program and the field system shares the software and includes a hardware component such as a computer or personal digital assistant that can receive engineering information related to a construction project from a database or spreadsheet, format the information so that it can be used to create an overall specification and provide products and services to that specification for a specific construction project. The system generates custom orders for products, manages fulfillment of the orders, and provides remote tracking capability using the computer via a PDA to verify and quantify project progress.

The invention further provides a method of doing business creating customized orders for construction products by use of a host system which receives written or electronic information from an engineering company for a construction project, transfers the information to a software program that re-formats the information to provide data at the component level that is used in determining specific products, marking requirements and making electrical project management calculations.

In one preferred embodiment, the method of doing business provides automated information at the “termination point” level for electrical features of the project that is used in determining specific products, marking requirements and making electrical project management calculations for electrical components and subcomponents required. The automated system manages the “termination point” data for cabling, routing, marker etc in a standard format and in one software package, manages revision levels and changes to engineering data among several entities, analyzes data and reports only “changes”, tracks progress of the project in terms of work completion and productivity, distributes information that has been re-formatting by the software using email to support portability in the field, sorts termination data by specific location, device or system, and generates orders for electrical identification products to be delivered.

The method of doing business selects an area, enclosure or device, groups required labels according to such area, enclosure or device and prints all labels in the group. No further data entry is required.

As used herein, these terms have the following meanings:

1. The term “area” means a three dimensional geographical area within a construction project.

2. The terms “masterpak” and “master carton” mean a carton containing multiple products related to one device within a specific system(s) or area(s) in the project. The products may be similar, identical or totally different from one another.

3. The term “termination point” refers to data regarding the point at which an electrical connection is made.

4. The term “raceway” refers to a holder for wires or cables, such as a conduit or cable tray.

5. The term “fulfillment” means providing the products ordered, packaging them as requested and delivering them in a timely fashion to the requested location. The term “portable system” means that the system is usable at different locations including mobile locations. While the field system may contain portable hardware, the term does not mean or require that all hardware for both the host system and the field system must be portable.

6. The term “mirror dataset” means a copy of the original dataset.

### DETAILED DESCRIPTION OF THE INVENTION

The present invention is an electronic data interface system that is based on a mapped work process and the input of engineering data to include termination point information. The invention is a tool that provides a standard format for engineering revision communications, material and workflow customization, detailed project management tracking and analysis and material management and trending as related to the construction side of a project. This is possible through the use of product level, or for electrical projects “termination point” data essential for material estimating and specifications, progress reporting, trending analysis and electrical identification.

Physical System

The physical system has two interfacing components: a host system and a field system. Engineering data is input into a host system, creating a template based on the unique language/configuration of the data and formats the data per the construction workflow process. The host systems holds all archived data and manages any revisions or changes that are made to the data by any one of many involved parties such as the owner, an engineer or a contractor.

A field system will be provided that is created by the host template. This system is designed specifically for the construction process and is portable. The system will operate on a 32 bit Windows® operating system; Windows® software is owned and developed by Microsoft Corporation. Useful versions of Windows® operating software include Windows® 95, Windows® 98, Windows® ME, Windows® NT, Windows® 2000, and Windows® XP Professional or Windows® XP Home are compatible with the system, which will also migrate to Apple Computer Inc. operating system Mac Native, if preferable. Hard drive space of 20 megabytes or greater is adequate for use of the system. The field database is activated on a project basis by means of a time sensitive password.

Customer Input Value Pyramid

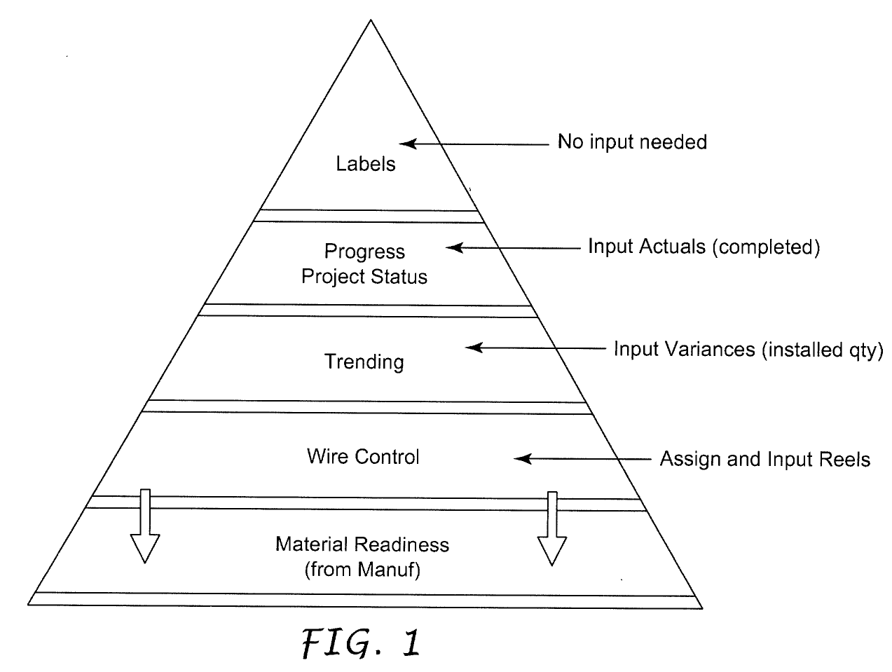

The individual customer determines the level of input for each project and therefore the level of return that can be achieved from the system. As shown in FIG. 1, the customer can order customized electrical identification products to be delivered in a work process format by merely selecting; e.g., clicking on a box within the software, the system marks and labels to be printed (“Labels” at the top of the FIG. 1 pyramid). As seen in the figure, no input is needed for this level of return. If the customer wishes to input information, he can input (or “check”) that certain work tasks have been completed; the entire electrical project will have progress and status reporting available (Progress Project Status in FIG. 1). If the customer inputs “actual” installed lengths and quantities as opposed to the earlier engineering estimates, i.e., variances, project specialty and general material trending will be available (Trending in FIG. 1). This type of information will also provide forecasting and material readiness capabilities for manufacturers and distributors (Material Readiness in FIG. 1). If numbers are assigned to cable and wire reels, and the customer inputs that information into the software, a material and wire control system will be in place (Wiring in FIG. 1). By the implementation of three easy steps the project can be better managed through the use of accurate marking, project progress and status, material trending and control.

Communication Flow

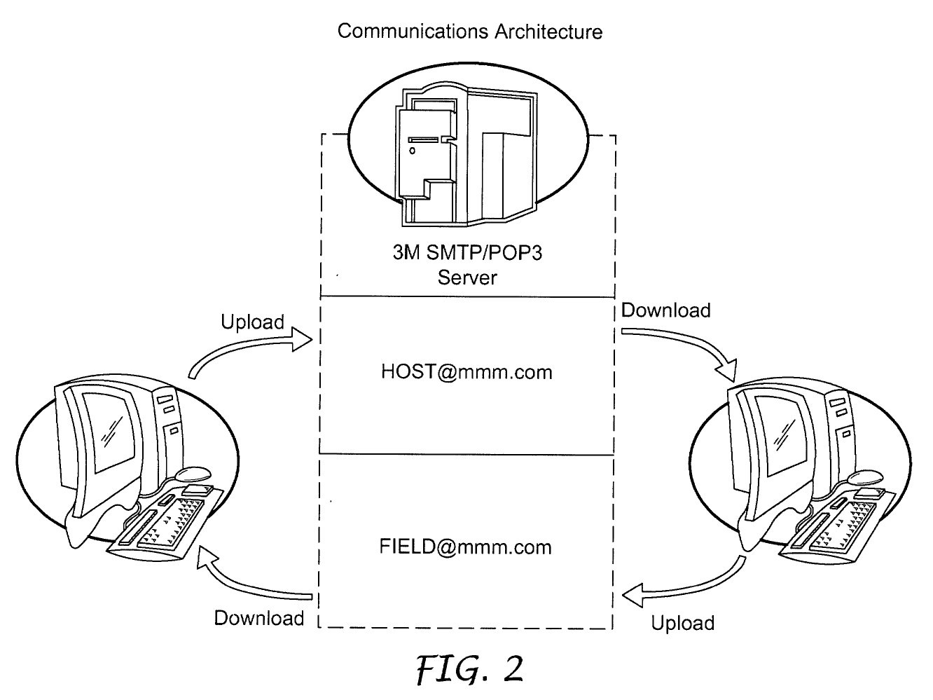

FIG. 2 is a schematic representation of the communication flow in the system. Communication of revisions between the “field” data and the previous “engineering” data will be managed via the host system. Communications will take place via a SMTP/POP3 server platform through email synchronization. A mirror copy of each dataset resides within the database, and all updates uploaded in the field are downloaded into the server, (marked “upload” into the field system on FIG. 2), and are then downloaded into the host server and are coded for change. The details and receipt of the updates are verified and confirmed before the mirror datasets are updated. As shown in FIG. 2, the host will then download those updates back to the field. A transfer impact and report log will provide information regarding non-critical or anticipated changes, critical changes or inventory or identification impacts. All changes are date and time stamped.

Material and Workflow Customization

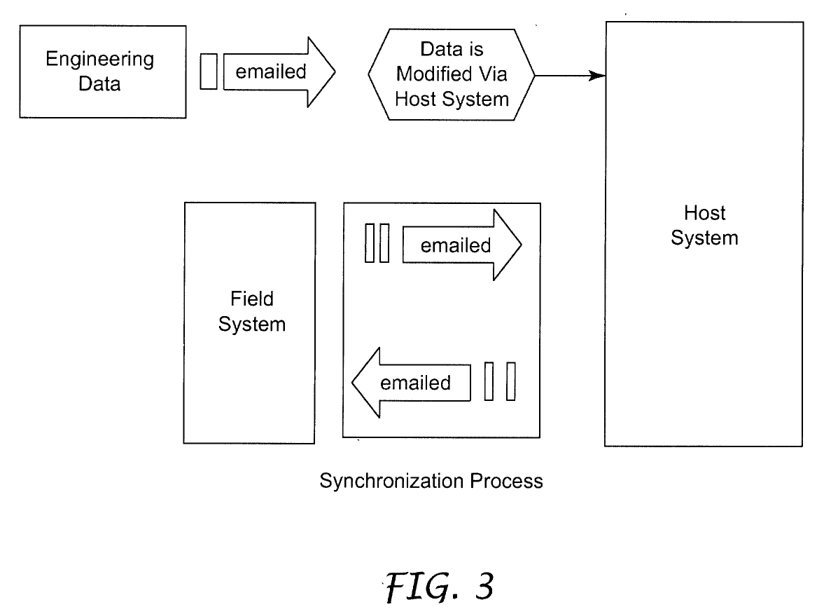

FIG. 3 is a schematic representation of the work process and material staging benefits provided by use of the portable system and business method of the invention.

The system provides a tool to define the process requirements regarding data sources, configurations and system interfaces. Engineers generate designs (Engineering data on figure); engineering data is then modified from the defined formats into a usable unique template within the host system. As shown in the figure, updates are emailed between the host system and the field system. For electrical projects, data and tools within the system provide specifications for specific products types required for electrical identification and termination needs. This methodology includes ordering and printing samples for approval, calculating material quantities and researching the scope and then pricing the project via the described system. The time and effort required to sort through the data to determine the information to be printed, the organization and logistics of ordering and printing materials and then staging at the devices will be drastically reduced.

The project data is converted to a field copy via the unique template. This version is provided to the customer, which includes the engineering data and the software tool to be used in the management of the construction process and its assets. The system is portable can be run remotely and is updated via the synchronization process described above.

The invention will provide a method for doing business that will sort product information for the various projects system, device, area, or other entered criteria for the specific workflow process of that project. For electrical projects this product information (cable ID, wire ID, equipment ID, conduit and tray ID), is sorted by system, device, area, cable etc. Products are ordered, printed, delivered and staged at the construction site via the selections from the customer. For electrical projects the customer will choose the marker sorting requirements (area, system, device) and will place the order for parts and services.

The unique configuration of the data provides the basis for detailed project management and materials trending. Earned hours, cross sectional analysis etc can all be accomplished through the detailed database information based on industry standards and specifications for cables and equipment. Work completion, as-built changes etc can be communicated via the synchronization process from a PDA to the Field version and from the Field Version to the Host. The field version becomes an “as-built” copy of the project itself and may be used for maintenance functions. The ability to rebuild portions of the site systems after fire or damage, troubleshooting capability and routine maintenance tracking are all key attributes to the completed project data.

This description is not meant to be limiting as variations can be readily made by one of skill in the art, and the scope of the invention is solely that which is defined by the claims.

What is claimed is:

1. A portable system comprising a host system having at least one software program and at least one hardware component, and a field system comprising a hardware component selected from a computer or personal digital assistant, said system capable of:
a) receiving engineering information related to at least a portion of construction project from a database or spreadsheet, formatting the information into a manufacturing format so that it can be used to create an overall specification and providing product and services for to that specification to the construction project, and
b) generating orders for products and managing fulfillment of the orders, and providing remote tracking capability using the computer or PDA to verify and quantify project progress.

2. A portable system according to claim 1 wherein said products are customized products.

3. A portable system according to claim 2 wherein orders are generated for at least one master carton containing multiple products for the same construction area, wherein criteria for said master carton have been preselected.

4. A portable system according to claim 1, wherein said software further transmits ordering information to a third party in the manufacturing format.

5. A portable system according to claim 1 wherein said software further distributes information regarding orders to contractors, subcontractors, vendors and other related personnel.

6. A portable system according to claim 1 wherein said at least a portion of the construction project is an electrical subproject.

7. A portable system according to claim 6 wherein products ordered include at least one routing or electrical termination product.

8. A portable system according to claim 6 wherein at least one label or marker for an electrical device is ordered.

9. A portable system according to claim 8 wherein said at least one label or marker is custom generated.

10. A portable system according to claim 8 wherein said at least one custom generated label list is packed together with a custom termination report.

11. A portable system according to claim 8 wherein customized cable labels are packed together with cable accessory kits.

12. A portable system according to claim 1 wherein orders are generated for at least one master carton containing multiple products for the same construction area, wherein criteria for said master carton have been preselected.

13. A business method comprising the steps of
a) receiving written or electronic engineering data from an engineering company for a construction project or subproject, and project milestones for said project,
b) transferring the information to a software program that re-formats the information to provide device level data for use in determining specific products, marking requirements and making project management calculations,
c) generating orders for electrical identification products to be delivered via use of said project milestones.

14. A business method according to claim 13 comprising the steps of:
a) receiving written or electronic engineering data from an engineering company for a construction project or subproject,
b) creating a unique template that translates individual company data into a language understood by the system and the industry.
c) transferring the information to a software program that re-formats the information to provide termination point data for use in determining specific products, marking requirements and making electrical project management calculations,
d) managing the “termination point” data for cabling, routing, and markers in a standard format and in one software package,
e) managing revision levels and changes to engineering data among several entities, analyzes data and reports any changes to said data,
f) tracking progress of the project by work completion,
g) distributing information by means of the software using email for portability,
h) sorting termination data by specific location, device or system, and
i) generating orders for electrical identification products to be delivered via entered project milestones,
j) Utilizing RFID for product ordering, material management and project tracking, and
k) Integrating supply chain process flow into the system as automated steps for ordering, customization, processing and fulfillment.

15. A business method according to claim 14 further comprising a step in which the software also generates invoicing over the Internet for products ordered.

16. A business method according to claim 14 wherein said invoicing is sent by email.

17. A kit comprising a set of wire markers specifically meeting requirements for a building's wiring subproject ordered by the system of claim 1, said markers being printed off site and delivered in a custom labeled package designating the intended location of said markers.

18. A pallet comprising a customized group of products selected and ordered by the system of claim 1.

19. A pallet according to claim 16 wherein said products are organized into at least one master carton.

20. A master carton including products for a single device or area of a construction project configured by the system of claim 1.
